(19) United States
(12) Patent Application Publication
(10) Pub. No.: US 2022/0398691 A1
(43) Pub. Date: Dec. 15, 2022

(54) CONTENT DISPLAY WITH FOCUSED AREA

(71) Applicant: CITRIX SYSTEMS, INC., FORT LAUDERDALE, FL (US)

(72) Inventors: DAOWEN WEI, NANJING (CN); JIAN DING, NANJING (CN); HENGBO WANG, NANJING (CN); FENG TAO, NANJING (CN)

(21) Appl. No.: 17/304,481

(22) Filed: Jun. 22, 2021

Related U.S. Application Data
(63) Continuation of application No. PCT/CN2021/099334, filed on Jun. 10, 2021.

(51) Int. Cl. G06T 3/40; G09G 5/00

(52) U.S. Cl. CPC G06T 3/4092; G09G 5/005; G06T 2200/16

(57) ABSTRACT

A computing device may include a processor and memory configured to determine a factor in which to scale content displayable on a client computing device based upon a ratio of physical sizes of different screens on which to display the content. One of the different screens may be that of the client computing device. The processor may be configured to select a portion of the content to display on the client computing device based on the determined factor and a position within the content at which there is an indication of interest. The processor may be further configured to transmit the selected portion of the content to the client computing device, so as to enable display of the selected portion rather than an entirety of the content.

### RELATED APPLICATIONS

This application is a continuation of U.S. application serial no. PCT/CN2021/099334 filed Jun. 10, 2021, which is hereby incorporated herein in its entirety by reference.

### TECHNICAL FIELD

The present disclosure relates to computing systems, and more particularly, to a computing system for sharing content.

### BACKGROUND

A multi-monitor environment is the use of multiple physical display devices, such as monitors, in order to increase the area available for programs and applications running on a single computer system. As an alternative to multiple physical display devices, a single large monitor may be used where the monitor is split into multiple virtual monitors. Regardless of the method, the typical screen real estate for a computer is growing.

It is now common to share content between different computing devices, for example, the desktop sharing feature on videoconferencing software.

### SUMMARY

Generally, a computing device may include a processor and memory coupled thereto. The processor may be configured to determine a factor in which to scale content displayable on a client computing device based upon a ratio of physical sizes of different screens on which to display the content, one of the different screens being that of the client computing device. The processor may be configured to perform selecting a portion of the content to display on the client computing device based on the determined factor and a position within the content at which there is an indication of interest, and transmitting the selected portion of the content to the client computing device, so as to enable display of the selected portion rather than an entirety of the content.

In some embodiments, the processor may be configured to update the position based upon a cursor position in the content. The processor may be configured to determine the factor based upon the updated position. The processor may be configured to update the factor in response to a change in the cursor position exceeding a threshold.

Also, the processor may be configured to determine the factor based upon a type of the content. The processor may be configured to, in response to the type of the content being indicative of image content, adjust the factor, and in response to the content type being indicative of text content, adjust the factor. The processor may be configured to, in response to the type of the content being indicative of text content, adjust the factor based upon a size of the text content.

The processor may be configured to receive the content from a host computing device. The processor may be configured to divide the content in a plurality of sections, and switch the position to one of the plurality of sections based upon user input.

Another aspect is directed to a method comprising determining a factor in which to scale content displayable on a client computing device based upon a ratio of physical sizes of different screens on which to display the content, one of the different screens being that of the client computing device. The method may also include selecting a portion of the content to display on the client computing device based on the determined factor and a position within the content at which there is an indication of interest. The method may include transmitting the selected portion of the content to the client computing device, so as to enable display of the selected portion rather than an entirety of the content.

Yet another aspect is directed to a non-transitory computer-readable medium having computer-executable instructions for causing a computing device to perform steps. The steps may comprise determining a factor in which to scale content displayable on a client computing device based upon a ratio of physical sizes of different screens on which to display the content, one of the different screens being that of the client computing device. The steps may comprise selecting a portion of the content to display on the client computing device based on the determined factor and a position within the content at which there is an indication of interest, and transmitting the selected portion of the content to the client computing device, so as to enable display of the selected portion rather than an entirety of the content.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing system for sharing content, according to a first example embodiment.

FIGS. 7A and 7B are schematic diagrams of screens of content from the host computing device being shared in the computing system of FIG. 6, and where the view of the client computing device is shown with dashed lines.

FIGS. 7C and 7D are schematic diagrams of screens of scaled content from the client computing device from FIGS. 7A and 7B, respectively.

FIG. 8 is a flowchart of a method for operating the computing system of FIG. 6.

FIG. 9 is a schematic block diagram of a computing system for sharing content, according to a second example embodiment.

FIG. 10 is a flowchart of an example embodiment of a method for operating the client computing device and the host computing device of FIG. 9.

FIG. 11 is a timing diagram within the method of FIG. 10.

FIG. 12A is a schematic block diagram of a computing system for sharing content, according to a third example embodiment.

FIGS. 12B and 12C are schematic diagrams of screens of content from the host computing device being shared in a computing system of FIG. 12A, and where the view of the client computing device is shown with dashed lines.

FIG. 13 is a timing diagram within the computing system of FIG. 12A.

### DETAILED DESCRIPTION

In recent years, it is not uncommon for an organization to have members spread out in different geographic locations, serving customers in various geographic regions, or simply working remotely in a flexible work environment. These organizations are turning to videoconference software, for example, Microsoft Teams, Zoom, GoToMeeting, Google Meet, to hold routine meetings, or to announce company efforts over video. Due to the COVID-19 pandemic, many organizations also encourage their members to work from home for safety reasons. Thereby, daily communications are generally shifting towards online collaborative platforms.

In typical videoconference software applications, there is a screen share option for a host computing device of the online meeting. Screen sharing ensures that everyone involved can view the display of the host computing device. Along with the popularity of high resolution monitors, the monitor layout is becoming bigger and tending to accommodate more content than ever before. At the same time, more users may operate with a mobile device with a significantly smaller screen size.

When a presenter shares a high resolution (e.g., 2K/4K) screen content in a remote meeting or a peer-to-peer call, it may be problematic for those participants joining from mobile devices to see the shared content clearly without additional zoom or pan commands. Usually, mobile users have to execute many touchscreen taps to zoom and navigate to the presented area or host computing device focus area, especially when many windows are arranged in a larger monitor. Further, mobile users have to again experience the poor user experience for zoom and navigation when a presented area is switched back and forth from one window to another window. If the host computing device switches frequently or switches across a longer distance, those participants from mobile devices easily get lost during the presentation, reducing the effectiveness of the online presentation.

The present disclosure may provide an approach to these issues. In particular, the approach includes dynamic and automatic scaling of the window pushed to the smaller screen mobile device, and also automatically follows the host screen's point of interest. In short, the approach keeps the mobile device view on the point of interest and scales it so it is easily viewable on the small screen mobile device.

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout, and base 100 reference numerals are used to indicate similar elements in alternative embodiments.

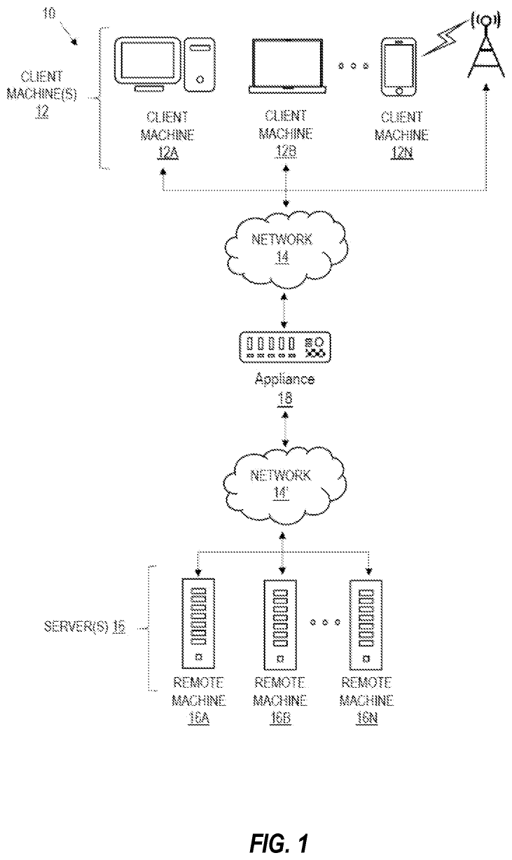

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 18 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

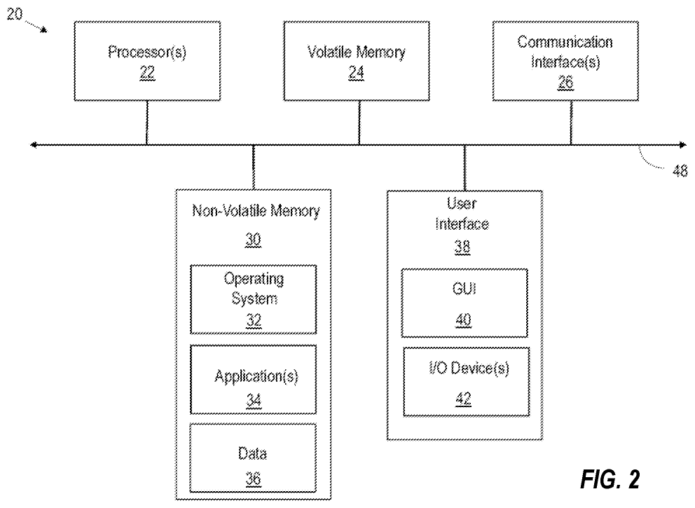

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a GUI 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Fla. (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

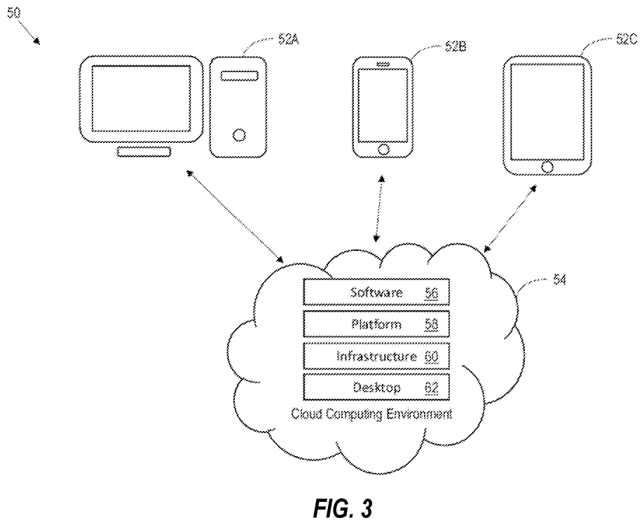

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft ONEDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

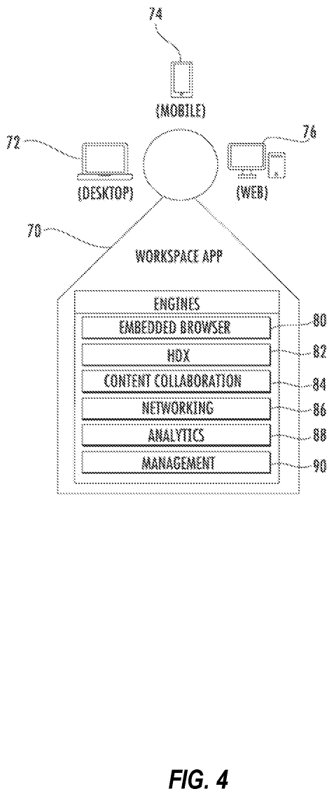

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

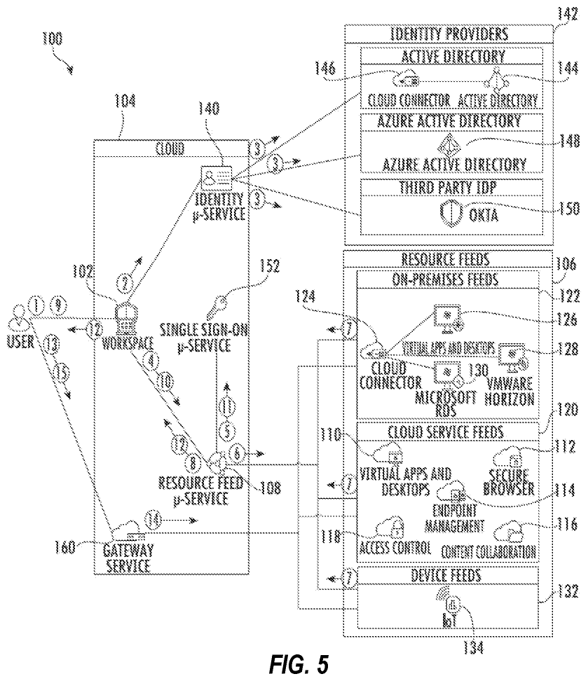

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

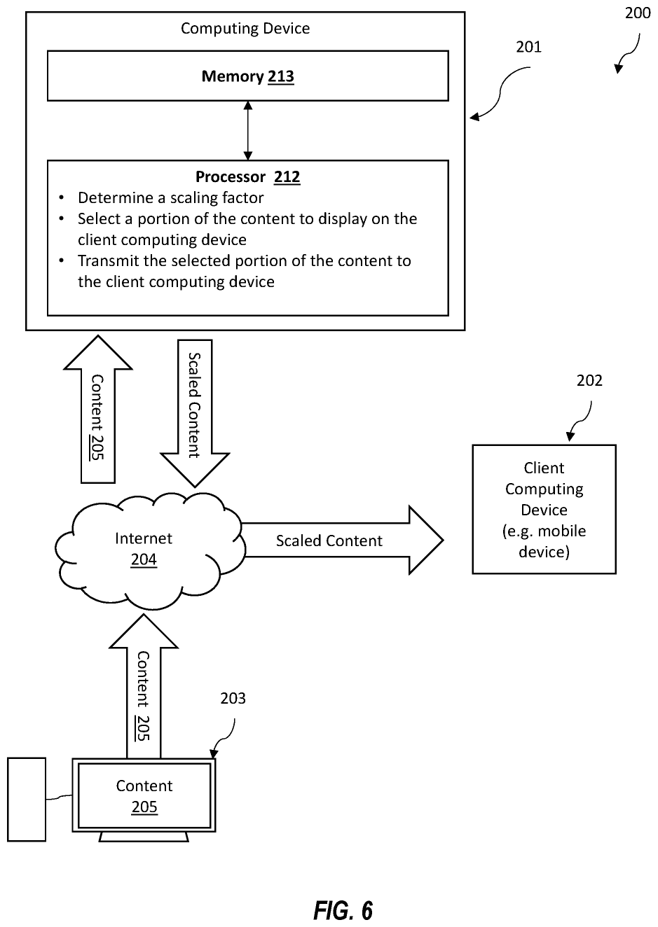

Advantageously, the present disclosure may provide an improved user experience for those participants joining from mobile devices when a host computing device shares screen content from a larger format monitor or multi-monitor setup. Referring now to FIG. 6, a computing system 200 according to the present disclosure is now described. The computing system 200 illustratively comprises a computing device 201, a client computing device 202, and a host computing device 203 in communication with the computing device and the client computing device over the network 204 (e.g. the Internet, or LAN). The host computing device 203 is configured to generate content 205, which is to be shared with the client computing device 202.

Advantageously, the computing system 200 may provide an improved user experience for the user of the client computing device 202 when the host computing device 203 shares the content 205 from a large format monitor (e.g. high resolution monitor) or multi-monitor setup (e.g. aggregate high resolution screen). In particular, the computing system 200 provides an approach to detect a cursor position of the shared content 205 from the host computing device 203 and set it as a geometric center to push a scaled screen or display of content that best-fits client computing device 202 screen size.

For example, the content 205 may comprise one or more of shared desktop content, shared image content, shared text content, SaaS application content, web application content, and native application content. In the illustrated embodiment, the content 205 comprises a shared desktop (as in the illustrated example of FIG. 6) comprising an application interface 206 (e.g., dock interface, start menu), a text content window 207, an image content window 210 (e.g. image files or video files), and a cursor 211. For example, the text content window 207 and the image content window 210 may be generated by a SaaS application, a web application, or/and a native application.

For example, the computing device 201 may comprise a standalone server, resources on a cloud computing platform, or a virtualized server as disclosed hereinabove in FIGS. 1-5. Also, the host computing device 203 may comprise a desktop computing device, a tablet computing device, or a laptop computing device, for example, and the client computing device 202 may comprise a mobile cellular device, or a tablet computing device (i.e. a device with a smaller screen than the host computing device). In particular, the content 205 is transmitted via the Internet 204 from the host computing device 203 and to the computing device 201, and then subsequently shared with the client computing device 202.

The computing device 201 illustratively includes a processor 212 and memory 213 coupled to the processor. The processor 212 is configured to receive the content 205 from the host computing device 203, and receive a message (e.g., a registration message) from the client computing device 202. The message may include capabilities, including screen physical dimensions, a dots per inch value, a screen resolution, and a screen display mode (e.g., portrait or landscape mode).

The processor 212 is configured to determine a factor or other value in which to scale the content 205 displayable on the client computing device 202 based upon a ratio of physical sizes of different screens on which to display the content. The different screens comprise a screen of the client computing device 202 and a screen of the host computing device 203. As will be appreciated, the screen of the client computing device 202 may have physical dimensions less than that of the screen of the host computing device 203. For example, the host computing device 203 may comprise a multi-monitor desktop computing device; and the client computing device 202 may comprise a mobile computing device. Because of these display differences, the client computing device 202 can only view a small portion of the content 205 from the host computing device 203.

More specifically, the processor 212 is configured to calculate the width and the height of a graphic area (i.e. the scaled content pushed to the client computing device 202) in pixels to be delivered with a best fit for the client computing device screen for clear viewing based upon the following equations 1-2. In other words, the below formulas map out the graphic area in x-y pixels to extract from the content 205 and to send to the client computing device 202.

Width in pixels=(Factor for scaling)×Resolution width×((Physical width of client screen)/(Physical width of server screen)) (1)

Height in pixels=(Factor for scaling)×Resolution height×((Physical height of client screen)/(Physical height of server screen)) (2)

As noted in the formulas, the graphic rectangle depends on the physical size of both screens of the client computing device 202 and the host computing device 203. Meanwhile, the width and the height of the graphic block (i.e. the scaled content pushed to the client computing device 202) can be scaled up or down based on the graphic content therein. By default, the factor for scaling is initialized to 1, but, it can be changed based upon the content type as discussed herein.

In particular, the scaling factor is dependent on a font size of the area of interest, and the default value of scaling factor is 1. For example, assuming the standard font size is 14 and scaling factor set to 1, when the font size is adjusted to 11, the scaling factor is (1.0*11/14).

The processor 212 is configured to select a portion 214 of the content 205 to display on the client computing device 202 based on the determined factor and a position within the content at which there is an indication of interest. In short, the processor 212 is configured to determine the indication of interest based upon input from the user of the host computing device 203.

More specifically, the position within the content 205 at which there is the indication of interest may comprise a position of the cursor 211. In other words, the processor 212 is configured to set the geometric center of the selected portion to be the cursor position (i.e. following the attention of the user of the host computing device 203). The processor 212 is configured to determine the position within the content 205 at which there is the indication of interest additionally or alternatively based upon location of selected content (e.g. selected text or selected window), an input field or area, or an active window.

The processor 212 is configured to update the position based upon a cursor position in the content 205. The processor 212 is configured to determine the factor based upon the updated position. The processor 212 is configured to update the factor when (i.e. in response to) a change in the cursor position exceeds a threshold (e.g. between 1%-5% of linear screen length or width). However, frequent movement of the cursor 211 may cause frequent graphics updating and screen flickering, which may be less than desirable for the user of the client computing device 202. Thereby, application of a threshold to the movement of the cursor 211 may avoid unnecessary graphics updating by detecting cursor movement distance between last recorded position and the current position. By default, the threshold distance is set to maximum value of half width or half height of a graphic block, but this value can be tuned.

The processor 212 is configured to transmit the selected portion of the content 205 to the client computing device 202, so that the position of the content indicated as being of interest remains in focus on the screen of the client computing device, or so as to enable display of the selected portion 214 rather than an entirety of the content. In short, processor 212 is configured to provide the client computing device 202 with the optimum portion of the content 205, so that the user is not needlessly attempting to reorient viewable content. More so, only graphic data with best fit size will be delivered to client computing device 202. Helpfully, the user of the client computing device 202 may not need to zoom and pan manually. Furthermore, the selected portion automatically follows the cursor 211 and the presented area without additional movement and search by the user.

Although the processor 212 is configured to execute auto-follow techniques for the selected portion, the user of the client computing device 202 may manually move or zoom for a more accurate content display. In other words, the auto-follow feature offers an initial and quick location to follow the presented area with a best fit size from the host computing device 203. Nevertheless, the user could manually move or zoom as in typical approaches to meet their expectations (i.e. making adoption easier). Even if additional movement or zooming is required occasionally, the number of taps and effort are decreased as compared to typical approaches. In other words, the processor 212 gets the selected portion close, permitting the user to make minor tweaks in location and zoom.

Users often zoom in on text content for clear view (i.e. to avoid lossy and hard to read text), especially with smaller font size, while zooming out for image or video area to get a larger view in context. Thereby, the processor 212 is configured to dynamically scale up or down based on the content near to the cursor 211, instead of a fixed factor for scaling.

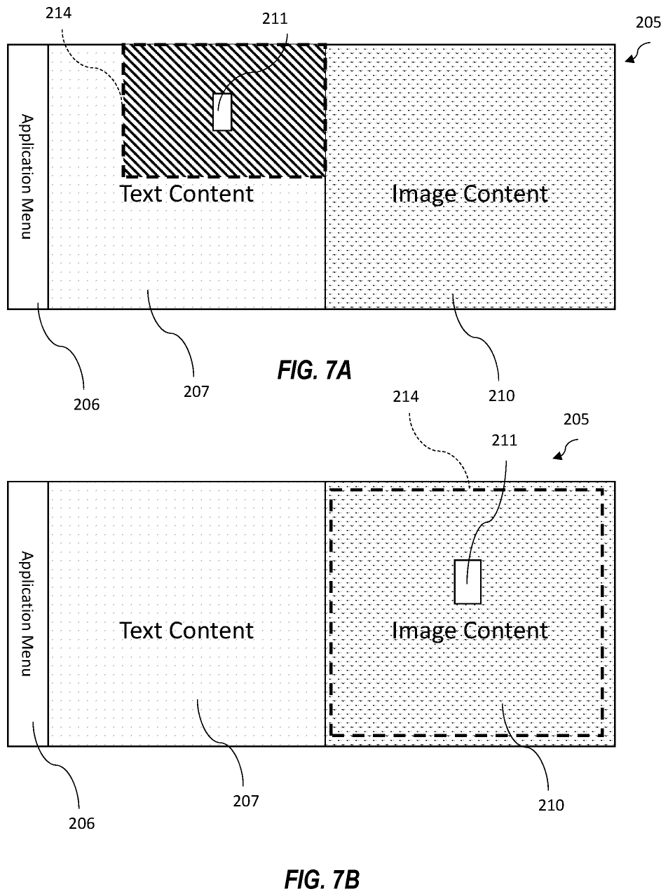

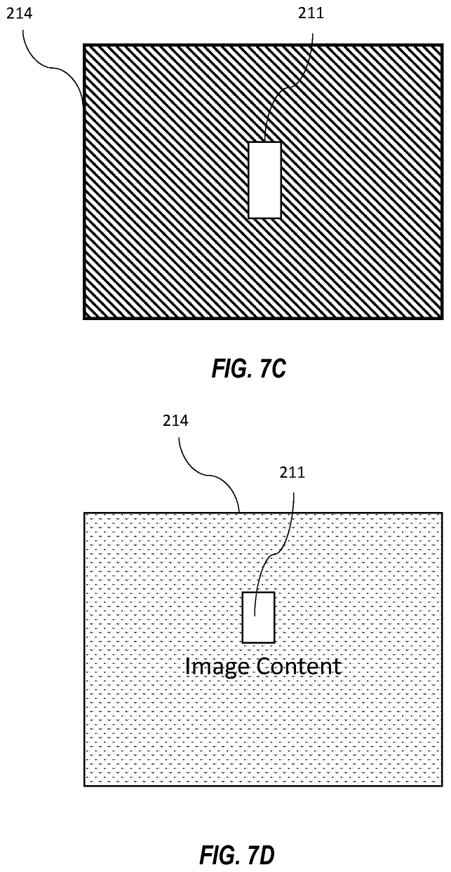

Referring now additionally to FIGS. 7A-7D, the processor 212 is configured to determine the factor based upon a content type within the content 205. Here, the selected portion is shown as the dashed line box 214, which is transmitted to the client computing device 202.

In FIGS. 7A & 7C, the position within the content 205 at which there is an indication of interest comprises the location of the cursor 211, and the cursor is situated over the text content window 207. Because of this, the selected portion is over the text content window 207, and the processor 212 is configured to, when (i.e. in response to) the content type comprises text content, decrease the factor for scaling. In other words, the selected portion encompasses a smaller swath of the content 205 from the host computing device 203, i.e. the view needs to zoom in so the text is readable at the client computing device 202. In some embodiments, the processor 212 may be configured to decrease the factor for scaling based upon a font size of the text content. In particular, a larger font size allows for a reduction in an amount of the decrease of the factor for scaling.

In FIGS. 7B & 7D, the position within the content 205 at which there is an indication of interest comprises the location of the cursor 211, and the cursor is situated over the image content window 210. In short, the user of the host computing device 203 has directed attention to the image content window 210. Because of this, the selected portion is over the image content window 210, and the processor 212 is configured to, when (i.e. in response to) the content type comprises image content, increase the factor for scaling. In other words, the selected portion encompasses a larger swath of the content 205 from the host computing device 203, i.e. zooming out so that the entire image content is viewable at the client computing device 202.

In the illustrated embodiment, the content scaling and determination of the selected portion is performed at the computing device 201. Moreover, although the content 205 is generated by the host computing device 203 in the illustrated embodiment, it should be appreciated that the computing device 201 may generate the content. In other embodiments, these functions may be performed by one or both of the host computing device 203 and the client computing device 202. Indeed, in such embodiments, the host computing device 203 may be omitted (i.e. a peer-to-peer content sharing arrangement).

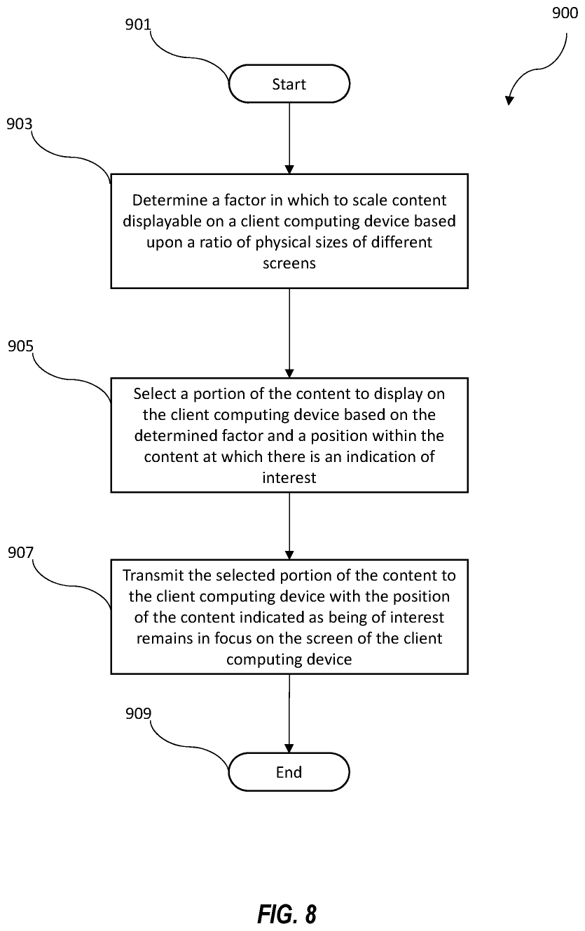

Referring now additionally to FIG. 8, a method of operating the computing device 201 is also described with reference to a flowchart 900, which begins at Block 901. The method illustratively includes determining a factor in which to scale content displayable on a client computing device 202 based upon a ratio of physical sizes of different screens on which to display the content, one of the different screens being that of the client computing device. (Block 903). The method also includes selecting a portion of the content 205 to display on the client computing device 202 based on the determined factor and a position within the content at which there is an indication of interest. (Block 905). The method comprises transmitting the selected portion of the content 205 to the client computing device 202, so that the position of the content indicated as being of interest remains in focus on the screen of the client computing device. (Block 907). The method ends at Block 909. Yet another aspect is directed to a non-transitory computer-readable medium having computer-executable instructions for causing a computing device to perform steps defined by the method above.

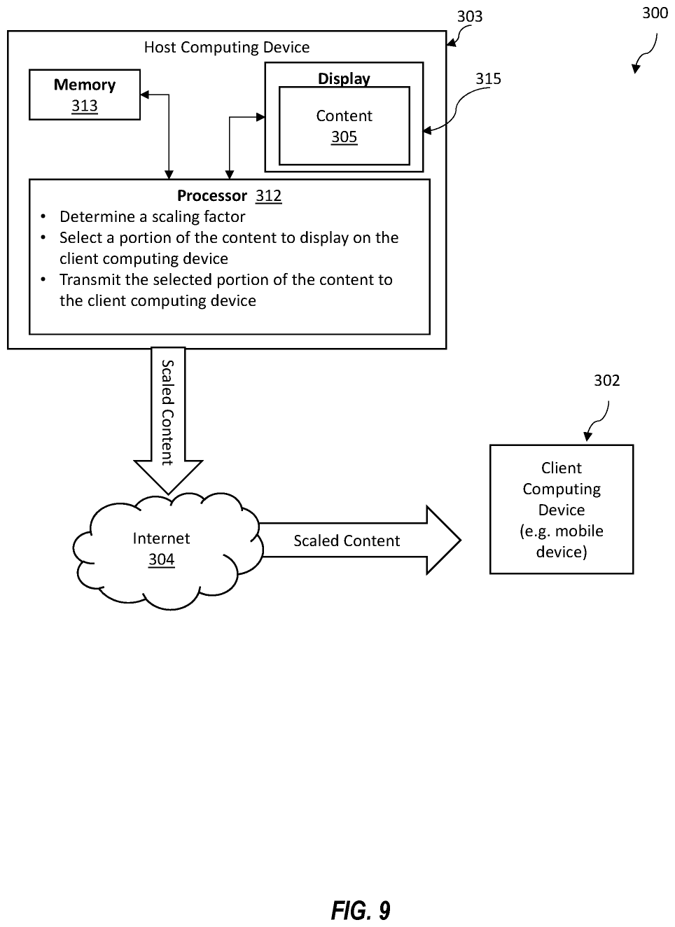

Referring now additionally to FIG. 9, another embodiment of the computing system 300 is now described. In this embodiment of the computing system 300, those elements already discussed above with respect to FIGS. 6-8 are incremented by 100 and most require no further discussion herein. This embodiment differs from the previous embodiment in that this computing system 300 illustratively omits the computing device 201 (FIG. 6), providing a peer-to-peer communication path. In other words, the host computing device 303 connects directly with the client computing device 302 via a network. Here, the host computing device 303 and the client computing device 302 communicate directly via the Internet 304. The host computing device 303 illustratively comprises a processor 312, a memory 313 coupled to the processor, and a display 315 coupled to the processor and showing content 305 to be shared. Also, the scaling and auto-follow teachings of the selected portion are performed by the host computing device 303. Of course, in other embodiments, the client computing device 302 may perform these functions rather than the host computing device 303.

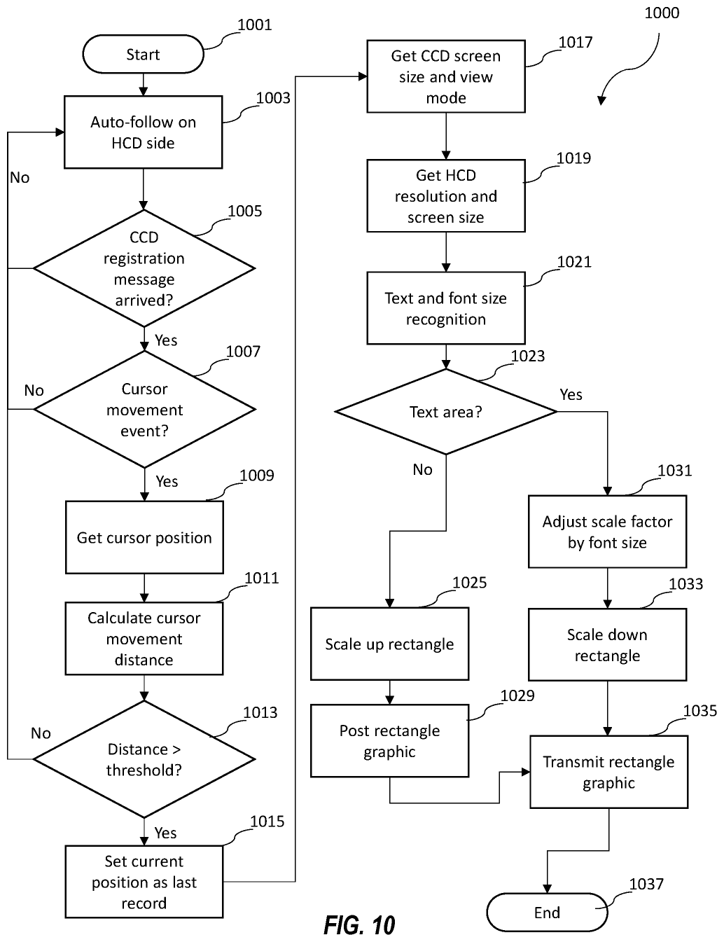

Referring now additionally to FIG. 10, a method of operating the computing system 300 is also described with reference to a flowchart 1000, which begins at Block 1001. Again here, the computing device 201 (FIG. 6) is omitted, and the processing is performed wholly by the client computing device 302 and the host computing device 303.

Once the host computing device 303 initiates sharing of the content 305, the computing device 301 is configured to execute an auto follow function. (Block 1003). The host computing device 303 is configured to receive a message (e.g., a registration message) from the client computing device 302, which indicates that the client computing device 302 is ready to receive the content 305 and includes the capabilities of the client computing device. (Block 1005). The host computing device 303 is configured to detect movement of the cursor 311, and if movement is detected, the cursor position is retrieved. (Blocks 1007, 1009, 1011). The host computing device 303 is configured to apply a threshold (e.g., a threshold of distance) to movements by the cursor 311, and if the movement exceeds the threshold, the host computing device is configured to update the position based upon a cursor position in the content 305. (Blocks 1013, 1015).

The host computing device 303 is configured to then retrieve the screen size and viewing mode of the client computing device 302, and the screen size and resolution of the host computing device 303. (Blocks 1017, 1019). The host computing device 303 is configured to then process the content 305 to detect text content, for example, performing optical character recognition processes. (Block 1021). If the content 305 comprises text content, the host computing device 303 is configured to adjust the factor for scaling based upon a font size of the text and scale down the selected portion. (Blocks 1023, 1031, 1033). Otherwise, the host computing device 303 is configured to adjust the scale up the selected portion. (Blocks 1025, 1029).

The host computing device 303 is configured to capture the selected portion, i.e. the graphic block. The host computing device 303 is configured to transmit the selected portion to the client computing device 302. (Block 1035). The client computing device 302 is configured to render the selected portion on a screen of the client computing device. The method ends at Block 1037.

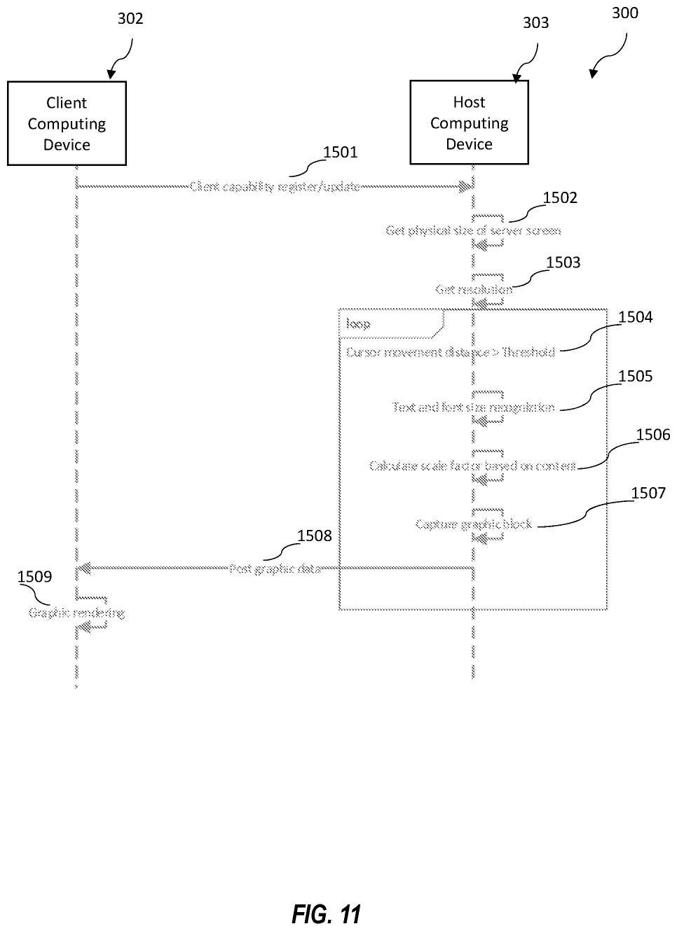

Referring now additionally to FIG. 11, a timing diagram is used to describe steps for the method of operating the computing system 300. Again here, the computing device 201 (FIG. 6) is omitted, and the processing is performed wholly by the client computing device 302 and the host computing device 303. The host computing device 303 is configured to receive a message (e.g., a registration message) from the client computing device 302, which indicates that the client computing device 302 is ready to receive the content 305 and includes the capabilities of the client computing device. (Step 1501). The host computing device 303 is configured to detect movement of the cursor 311, and if movement is detected, the cursor position is retrieved. The host computing device 303 is configured to apply a threshold to movements by the cursor 311, and if the movement exceeds the threshold, the host computing device is configured to update the position based upon a cursor position in the content 305. (Step 1504).

The host computing device 303 is configured to then retrieve the screen size and viewing mode of the client computing device 302, and the screen size and resolution of the host computing device 303. (Steps 1502, 1503). The host computing device 303 is configured to then process the content 305 to detect text content, for example, performing optical character recognition processes. (Step 1505). If the content 305 comprises text content, the host computing device 303 is configured to adjust the factor for scaling based upon a font size of the text and scale down the selected portion. Otherwise, the host computing device 303 is configured to adjust the scale up the selected portion. (Step 1506).

The host computing device 303 is configured to capture the selected portion, i.e. the graphic block. (Step 1507). The host computing device 303 is configured to transit the selected portion to the client computing device 302. (Step 1508). The client computing device 302 is configured to render the selected portion on a screen of the client computing device. (Step 1509).

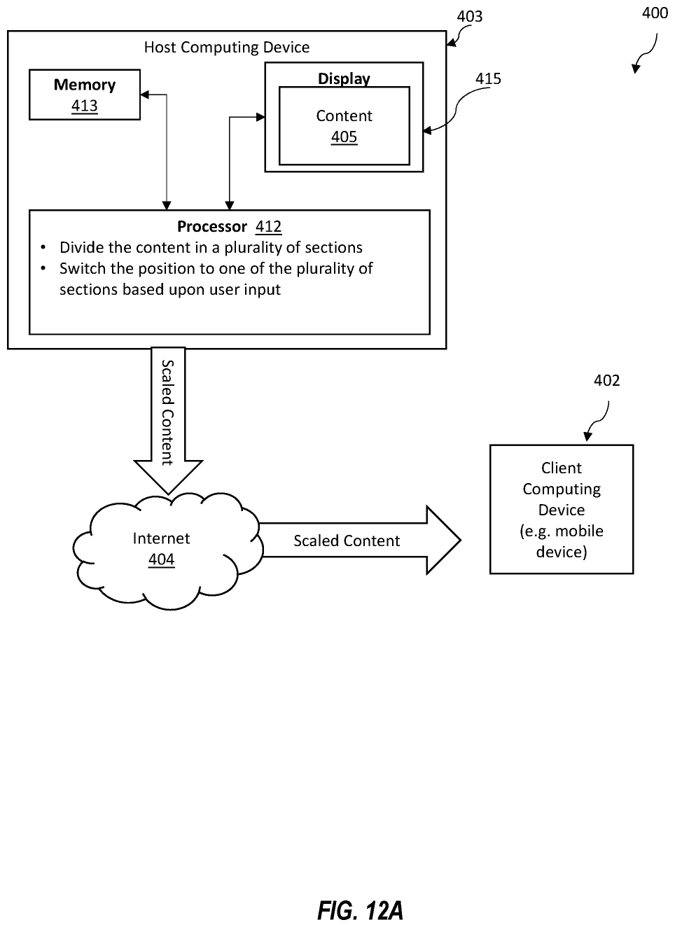

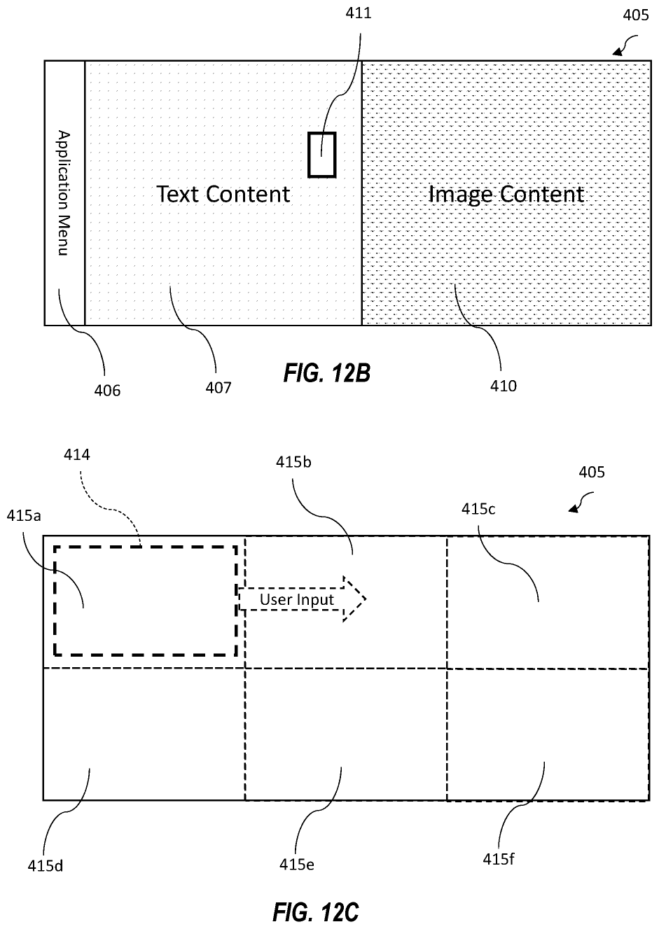

Referring now additionally to FIG. 12A, another embodiment of the computing system 400 is now described. In this embodiment of the computing system 400, those elements already discussed above with respect to FIGS. 6-8 are incremented by 200 and most require no further discussion herein. This embodiment differs from the previous embodiment in that this computing system 400 illustratively omits the computing device 201 (FIG. 6), providing a peer-to-peer communication path. In other words, this computing system 400 is similarly constituted to the computing system 300 of FIGS. 9-11. Nevertheless, it should be appreciated that the features of this embodiment can be applied to the computing systems 200, 300 of FIGS. 6 & 9.

Referring now additionally to FIG. 12B, the content 405 comprises a shared desktop comprising an application interface 406 (e.g., dock interface, start menu), a text content window 407, an image content window 410 (e.g. image files or video files), and a cursor 411. For example, the text content window 407 and the image content window 410 may be generated by a SaaS application, a web application, or/and a native application.

Referring now additionally to FIG. 12C, the processor 413 is configured to divide the content 405 into a plurality of sections 415a-415f. In the illustrated example, the sections 415a-415f are each sized equally. The processor 413 is configured to switch the position to one of the plurality of sections 415a-415f based upon user input. Here, shown with the dashed arrow, the user input directs a switch of the selected portion 414 from the first section 415a to the second section 415b.

Although the above embodiments (FIGS. 6-11) describe features for automatically selecting a portion without user interaction at the client computing device 402, the computing system 400 includes a feature for user manipulating the selected portion 414 in addition to or in alternative to the automatic selection process described hereinabove. In other words, if the user of the client computing device 402 disagrees with the automatically generated selected portion, the user may manually change this selection. For example, the user may use the directional input of the client computing device 402 to switch directionally between the plurality of sections 415a-415f, for example, using a virtual or physical directional pad or touch screen swipe inputs. Of course, since the content 405 size is quite large with respect to the screen size of the client computing device 402, manual selection may result in the user awkwardly pan and scanning the content 405, which may be less than desirable.

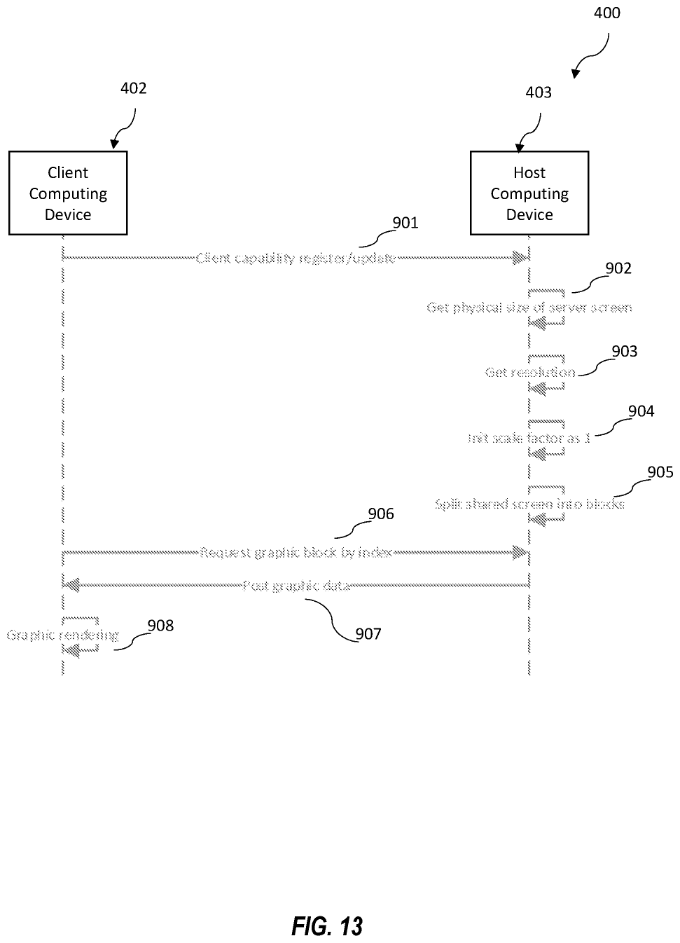

Referring now to a timing diagram in FIG. 13, the host computing device 403 is configured to retrieve the capabilities (e.g. screen size, screen resolution, processing power) of the client computing device 402. (Step 901). The host computing device 403 is configured to determine the screen size, screen resolution of the host computing device screen. (Steps 902, 903). The host computing device 403 is configured to initiate the factor for scaling at 1, and the divide the content 405 in a plurality of sections 415a-415f. (Steps 904, 905). As will be appreciated, the scaling teachings discussed hereinabove can be applied here also. The width and the height of individual sections 415a-415f in pixels is calculated based upon resolution and physical screen size in host computing device 403, together with the physical screen size of client computing device 402.

The host computing device 403 is configured to switch the position to one of the plurality of sections 415a-415f based upon user input from the client computing device 402. (Step 906). The host computing device 403 is configured to transmit the selected portion to the client computing device 402, which is rendered onto a display of the client computing device. (Steps 907, 908). More specifically, the user may use the directional input of the client computing device 402 to switch directionally between the plurality of sections 415a-415f, for example, using a virtual or physical directional pad or touch screen swipe inputs. Here, the scaling for individual sections 415a-415f is fixed, but the user can switch back and forth between the manual switching mode and the auto-follow mode discussed hereinabove.

In this approach of the present disclosure, the shared content 405 in the larger monitor is split into several best-fit client screen size with an index system. The user of the client computing device 402 may navigate screen indices to a target area with a clear view. It not only offers a shortcut path for content navigation, but also provides an asynchronous method to view other non-presented areas.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a processor and memory coupled thereto and configured to performing the following:
determining a factor in which to scale content displayable on a client computing device based upon a ratio of physical sizes of different screens on which to display the content, one of the different screens being that of the client computing device,
in response to a type of the content being indicative of image content, increasing the factor in which to scale content displayable on the client computing device,
in response to the type of the content being indicative of text content, decreasing the factor in which to scale content displayable on the client computing device,
selecting a portion of the content to display on the client computing device based on the determined factor and a position within the content at which there is an indication of interest, and
transmitting the selected portion of the content to the client computing device, so as to enable display of the selected portion rather than an entirety of the content.

2. The computing device of claim 1 wherein said processor is configured to update the position based upon a cursor position in the content.

3. The computing device of claim 2 wherein said processor is configured to determine the factor based upon the updated position.

4. The computing device of claim 2 wherein said processor is configured to update the factor in response to a change in the cursor position exceeding a threshold.

5. (canceled)

6. (canceled)

7. (canceled)

8. The computing device of claim 1 wherein said processor is configured to receive the content from a host computing device.

9. The computing device of claim 1 wherein said processor is configured to:
divide the content in a plurality of sections; and
switch the position to one of the plurality of sections based upon user input.

10. A method comprising:
determining a factor in which to scale content displayable on a client computing device based upon a ratio of physical sizes of different screens on which to display the content, one of the different screens being that of the client computing device;
in response to a type of the content being indicative of image content, increasing the factor in which to scale content displayable on the client computing device;
in response to the type of the content being indicative of text content, decreasing the factor in which to scale content displayable on the client computing device;
selecting a portion of the content to display on the client computing device based on the determined factor and a position within the content at which there is an indication of interest; and
transmitting the selected portion of the content to the client computing device, so as to enable display of the selected portion rather than an entirety of the content.

11. The method of claim 10 further comprising updating the position based upon a cursor position in the content.

12. The method of claim 11 further comprising determining the factor based upon the updated position.

13. The method of claim 11 further comprising updating the factor in response to a change in the cursor position exceeding a threshold.

14. (canceled)

15. (canceled)

16. The method of claim 10 further comprising:
dividing the content in a plurality of sections; and
switching the position to one of the plurality of sections based upon user input.

17. A non-transitory computer-readable medium having computer-executable instructions for causing a computing device to perform steps comprising:
determining a factor in which to scale content displayable on a client computing device based upon a ratio of physical sizes of different screens on which to display the content, one of the different screens being that of the client computing device;
in response to a type of the content being indicative of image content, increasing the factor in which to scale content displayable on the client computing device;
in response to the type of the content being indicative of text content, decreasing the factor in which to scale content displayable on the client computing device;
selecting a portion of the content to display on the client computing device based on the determined factor and a position within the content at which there is an indication of interest; and
transmitting the selected portion of the content to the client computing device, so as to enable display of the selected portion rather than an entirety of the content.

18. The non-transitory computer-readable medium of claim 17 wherein the steps comprise updating the position based upon a cursor position in the content.

19. The non-transitory computer-readable medium of claim 18 wherein the steps comprise determining the factor based upon the updated position.

20. The non-transitory computer-readable medium of claim 18 wherein the steps comprise updating the factor in response to a change in the cursor position exceeding a threshold.

21. The non-transitory computer-readable medium of claim 17 wherein the content is received from a host computing device.

22. The non-transitory computer-readable medium of claim 21 wherein the steps comprise receiving screen resolution and screen size for the host computing device and the client computing device.

23. The non-transitory computer-readable medium of claim 17 wherein the steps comprise:
dividing the content in a plurality of sections; and
switching the position to one of the plurality of sections based upon user input.

24. The computing device of claim 8 said processor is configured to receive screen resolution and screen size for the host computing device and the client computing device.

25. The method of claim 10 wherein the content is received from a host computing device; and further comprising receiving screen resolution and screen size for the host computing device and the client computing device.
